(19) United States
(12) Patent Application Publication
(10) Pub. No.: US 2024/0049081 A1
(43) Pub. Date: Feb. 8, 2024

(54) MEASUREMENT REPORTING BASED RELAY PATH RECOVERY FOR LAYER 2 (L2) USER EQUIPMENT (UE) TO UE (U2U) RELAY

(71) Applicant: Apple Inc., Cupertino, CA (US)

(72) Inventors: Peng Cheng, Beijing (CN); Zhibin Wu, Los Altos, CA (US); Haijing Hu, Los Gratos, CA (US); Yuqin Chen, Beijing (CN); Fangli Xu, Beijing (CN); Ping-Heng Kuo, London (GB); Alexander Sirotkin, Hod Hasharon (IL); Naveen Kumar R Palle Venkata, San Diego, CA (US); Ralf Rossbach, Munich (DE)

(21) Appl. No.: 18/313,680

(22) Filed: May 8, 2023

Related U.S. Application Data
(60) Provisional application No. 63/395,908, filed on Aug. 8, 2022.

(51) Int. Cl. H04W 36/00; H04W 76/14; H04W 36/30

(52) U.S. Cl. CPC H04W 36/03; H04W 76/14; H04W 36/0085; H04W 36/305

(57) ABSTRACT

A user equipment (UE), a baseband processor or other network device can operate in a new radio (NR) unlicensed network can operate to communicate in a UE to UE (U2U) relay path through a first relay UE with another UE as a source or destination UE according to a direct communication request initiating from the source UE. The UE, as a source UE, can also perform the U2U relay reselection based on a measurement report received from a destination UE.

### REFERENCE TO RELATED APPLICATIONS

The application claims the benefit of U.S. Provisional Patent Application 63/395,908 filed Aug. 8, 2022, entitled “MEASUREMENT REPORTING BASED RELAY PATH RECOCVERY FOR LAYER 2 (L2) USER EQUIPMENT (UE) TO UE (U2U) RELAY”, the contents of which are herein incorporated by reference in their entirety.

### FIELD

The present disclosure is related to wireless technology, and more specifically, pertains to layer 2 (L2) UE to UE (U2U) relay path recovery.

### BACKGROUND

As the number of mobile devices within wireless networks, and the demand for mobile data traffic, continue to increase, changes are made to system requirements and architectures to better address current and anticipated demands. For example, some wireless communication networks (e.g., fifth generation (5G) or new radio (NR) networks) may be developed to include UE to UE (U2U) relay communication. In such scenarios, path recovery and relay reselection enhancements can be made.

### BRIEF DESCRIPTION OF THE DRAWINGS

FIG. 1 illustrates an exemplary block diagram illustrating an example of user equipment(s) (UEs) communicatively coupled a network with network components as peer devices useable in connection with various embodiments (aspects) described herein.

FIG. 2 illustrates an example simplified block diagram of a user equipment (UE) wireless communication device or other network device/component (e.g., eNB, gNB) in accordance with various aspects.

FIG. 3 illustrates an example of UE to UE (U2U) relay communications for performing path recovery and relay reselection in accordance with various aspects.

FIG. 4 illustrates another example of U2U relay communications for performing path recovery and relay reselection in accordance with various aspects.

FIG. 5 illustrates another example of process flow of U2U relay communications for performing path recovery and relay reselection in accordance with various aspects.

FIG. 6 illustrates an example of process flow of U2U relay communications for performing path recovery and relay reselection in accordance with various aspects.

FIG. 7 illustrates a diagram illustrating example components of a device that can be employed in accordance with various aspects discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects include a user equipment (UE) operating in UE to UE (U2U) relay communication for performing a U2U relay reselection. An objective of sidelink (SL) relaying such as U2U is to extend coverage of SL communications, as well as the network. Moreover, power efficiency and enhanced QoS are also goals for enhancing U2U communication. Two types of relaying include UE-to-Network (U2N), used generally to extend cell coverage and provide reachability for cell-edge users (or out-of-coverage users) to reach the Packet Data Network (PDN), and U2U with a single hop SL communication. For out-of-coverage scenarios, the single hop SL communication may not be sufficient to ensure SL coverage. Therefore, a UE-to-UE relay can extend SL coverage.

Various further studies include relay (re)selection, relay/remote UE authorization, QoS provisioning, service continuity, and security mechanisms with respect to the relay node architecture (e.g., layer 2 (L2) or layer 3 (L3) of the protocol stack). In addition, U2U relay adaptation layer design, control plane procedures, and QoS handling can be specific to the L2 relay specific part.

Various aspects can include taking into account forward compatibilities for supporting more than one hop, or more than one relay link between a source UE or initiating UE via a relay UE to a target UE or destination UE. In one aspect, the remote UE can be connected to only a single relay UE at a particular time for a given destination UE.

In an aspect, a source UE comprising processing circuitry with at least one memory can operate to initiate a U2U relay by establishing a direct communication channel through a first relay UE to a destination UE. A U2U relay reselection can be performed by the source UE to a second relay UE in response to a trigger condition, which can be based on at least one of: a measurement of a first channel link to the first relay UE being below a pre-configured threshold, a detection of a radio link failure (RLF) on the first channel link, a notification based on a second channel link between the first relay UE and the destination UE, a reception of a release message, or a measurement report from the destination UE. The source UE then establish the U2U relay to the destination UE through the second relay UE.

In an aspect, U2U communications can include a second hop or a second channel link between the relay UE (R-UE) and the destination UE (D-UE) can initiate relay reselection as a part of relay establishment procedures for L2 U2U relay communications based on at least one trigger condition. A first channel link between the source UE (S-UE) and the R-UE, the second channel link, or both the first and second channel links can be PC5 links.

In an aspect, either one or both the S-UE or the D-UE can perform relay reselection. When relay reselection is performed (either triggered/initiated by the S-UE or the D-UE, the R-UE can notify the other UE or peer UE in U2U communication. Direct communication between vehicles or other devices such as UEs can use so-called public or mission critical (PC) 5 interface. PC5 refers to a reference point where the UE directly communicates with another UE over a direct channel. In this case, the communication with the base station is not required. In a system architectural level, proximity service (ProSe) is the feature that specifies the architecture of the direct communication between UEs. In 3GPP RAN specifications, “sidelink” is the terminology to refer to the direct communication over PC5. PC5 interface was originally defined to address the needs of mission-critical communication for public safety community (Public Safety-LTE, or PS-LTE) in release 13. The motivation of the mission-critical communication was to allow law enforcement agencies or emergency rescue to use the LTE communication even when the infrastructure is not available, such as in a natural disaster scenario. In release 14 onwards, the use of PC5 interface has been expanded to meet various market needs, such as communication involving wearable devices such as smartwatch. PC5 interface can be re-applied to the direct communication in mobile devices including UEs or Vehicle UEs. Additionally, a unicast can refers to a one-to-one transmission from one point in the network to another point; that is, one sender and one receiver, where each can have a network address uniquely identifying a single endpoint.

Additional aspects and details of the disclosure are further described below with reference to figures.

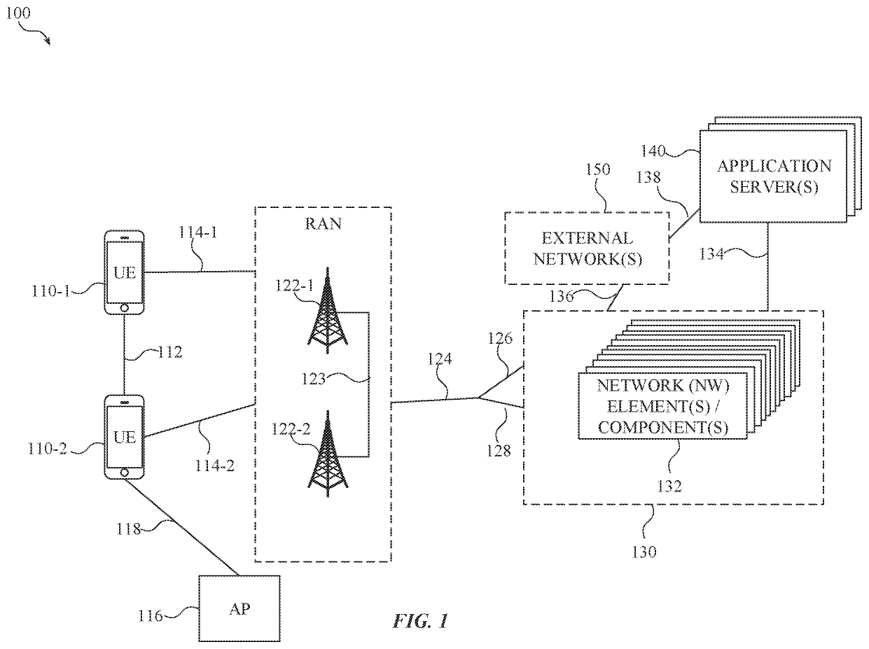

FIG. 1 is an example network 100 according to one or more implementations described herein. Example network 100 can include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 can include smartphones (e.g., handheld touchscreen mobile computing devices connectable to one or more wireless communication networks). Additionally, or alternatively, UEs 110 can include other types of mobile or non-mobile computing devices capable of wireless communications, such as personal data assistants (PDAs), pagers, laptop computers, desktop computers, wireless handsets, etc. In some implementations, UEs 110 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more.

UEs 110 can communicate and establish a connection with (be communicatively coupled to) RAN 120, which can involve one or more wireless channels 114-1 and 114-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 122-1 and 122-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 130. Additionally, at least one of the MN or the SN can be operated with shared spectrum channel access, and functions specified for UE 110 can be used for an integrated access and backhaul mobile termination (IAB-MT). Similar for UE 110, the IAB-MT can access the network using either one network node or using two different nodes with enhanced dual connectivity (EN-DC) architectures, new radio dual connectivity (NR-DC) architectures, or other direct connectivity such as a sidelink (SL) communication channel as an SL interface 112.

In some implementations, a base station (as described herein) can be an example of network node 122. As shown, UE 110 can additionally, or alternatively, connect to access point (AP) 116 via connection interface 118, which can include an air interface enabling UE 110 to communicatively couple with AP 116. AP 116 can comprise a wireless local area network (WLAN), WLAN node, WLAN termination point, etc. The connection 118 can comprise a local wireless connection, such as a connection consistent with any IEEE 702.11 protocol, and AP 116 can comprise a wireless fidelity (Wi-Fi®) router or other AP. AP 116 could be also connected to another network (e.g., the Internet) without connecting to RAN 120 or CN 130.

RAN 120 can also include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 can include network access points configured to provide radio baseband functions for data or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 can include a roadside unit (RSU), a transmission reception point (TRxP or TRP), and one or more other types of ground stations (e.g., terrestrial access points). In some scenarios, RAN node 122 can be a dedicated physical device, such as a macrocell base station, or a low power (LP) base station for providing femtocells, picocells or other like having smaller coverage areas, smaller user capacity, or higher bandwidth compared to macrocells. As described below, in some implementations, satellites 160 can operate as bases stations (e.g., RAN nodes 122) with respect to UEs 110. As such, references herein to a base station, RAN node 122, etc., can involve implementations where the base station, RAN node 122, etc., is a terrestrial network node and also to implementation where the base station, RAN node 122, etc., is a non-terrestrial network node.

Some or all of RAN nodes 122 can be implemented as one or more software entities running on server computers as part of a virtual network, which can be referred to as a centralized RAN (CRAN) or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 122; a media access control (MAC)/physical (PHY) layer split wherein RRC, PDCP, radio link control (RLC), and MAC layers can be operated by the CRAN/vBBUP and the PHY layer can be operated by individual RAN nodes 122; or a “lower PHY” split wherein RRC, PDCP, RLC, MAC layers and upper portions of the PHY layer can be operated by the CRAN/vBBUP and lower portions of the PHY layer can be operated by individual RAN nodes 122. This virtualized framework can allow freed-up processor cores of RAN nodes 122 to perform or execute other virtualized applications, for example.

In some implementations, an individual RAN node 122 can represent individual gNB-distributed units (DUs) connected to a gNB-control unit (CU) via individual F1 interfaces. In such implementations, the gNB-DUs can include one or more remote radio heads or radio frequency (RF) front end modules (RFEMs), and the gNB-CU can be operated by a server (not shown) located in RAN 120 or by a server pool (e.g., a group of servers configured to share resources) in a similar manner as the CRAN/vBBUP. Additionally, or alternatively, one or more of RAN nodes 122 can be next generation eNBs (i.e., gNBs) that can provide evolved universal terrestrial radio access (E-UTRA) user plane and control plane protocol terminations toward UEs 110, and that can be connected to a 5G core network (5GC) 130 via a Next Generation (NG) interface 124.

Any of the RAN nodes 122 can terminate an air interface protocol and can be the first point of contact for UEs 110. In some implementations, any of the RAN nodes 122 can fulfill various logical functions for the RAN 120 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations can not be limited in this regard. The OFDM signals can comprise a plurality of orthogonal subcarriers.

Further, RAN nodes 122 can be configured to wirelessly communicate with UEs 110, and/or one another, over a licensed medium (also referred to as the “licensed spectrum” or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 can operate using licensed assisted access (LAA), eLAA, and/or feLAA mechanisms. In these implementations, UEs 110 and the RAN nodes 122 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol or a clear channel assessment (CCA).

A physical downlink shared channel (PDSCH) can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) can be performed at any of the RAN nodes 122 based on channel quality information fed back from any of UEs 110. The downlink resource assignment information can be sent on the PDCCH used for (e.g., assigned to) each of UEs 110.

The PDCCH uses control channel elements (CCEs) to convey the control information, wherein a number of CCEs (e.g., 6 or the like) can consists of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, 8, or 16).

The RAN nodes 122 or RAN 120 can be configured to communicate with one another via interface 123. In implementations where the system is an LTE system, interface 124 can be an X2 interface. The X2 interface can be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface can include an X2 user plane interface (X2-U) 126 and an X2 control plane interface (X2-C) 128. The X2-U can provide flow control mechanisms for user data packets transferred over the X2 interface and can be used to communicate information about the delivery of user data between eNBs or gNBs. For example, the X2-U 126 can provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

Alternatively, or additionally, RAN 120 can be also connected (e.g., communicatively coupled) to CN 130 via a Next Generation (NG) interface as interface 124. The NG interface 124 can be split into two parts, a Next Generation (NG) user plane (NG-U) interface 126, which carries traffic data between the RAN nodes 122 and a User Plane Function (UPF), and the S1 control plane (NG-C) interface 128, which is a signaling interface between the RAN nodes 122 and Access and Mobility Management Functions (AMFs).

CN 130 can comprise a plurality of network elements 132, which are configured to offer various data and telecommunications services to customers/subscribers (e.g., users of UEs 110) who are connected to the CN 130 via the RAN 120. In some implementations, CN 130 can include an evolved packet core (EPC), a 5G CN, and/or one or more additional or alternative types of CNs. The components of the CN 130 can be implemented in one physical node or separate physical nodes including components to read and execute instructions from a machine-readable or computer-readable medium (e.g., a non-transitory machine-readable storage medium).

As shown, CN 130, application servers 140, and external networks 150 can be connected to one another via interfaces 134, 136, and 138, which can include IP network interfaces. Application servers 140 can include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 can also, or alternatively, be configured to support one or more communication services (e.g., voice over IP (VoIP sessions, push-to-talk (PTT) sessions, group communication sessions, social networking services, etc.) for UEs 110 via the CN 130. Similarly, external networks 150 can include one or more of a variety of networks, including the Internet, thereby providing the mobile communication network and UEs 110 of the network access to a variety of additional services, information, interconnectivity, and other network features.

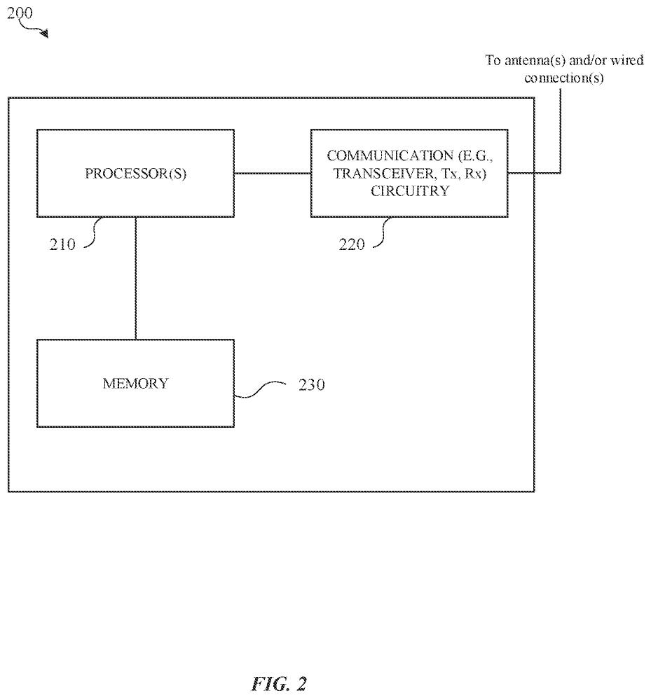

Referring to FIG. 2, illustrated is a block diagram of a UE device or other network device/component (e.g., V-UE/P-UE, IoT, gNB, eNB, or other participating network entity/component). The device 200 includes one or more processors 210 (e.g., one or more baseband processors) comprising processing circuitry and associated interface(s), transceiver circuitry 220 (e.g., comprising RF circuitry, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 230 (which can comprise any of a variety of storage mediums and can store instructions and/or data associated with one or more of processor(s) 210 or transceiver circuitry 220).

Memory 230 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Any connection can be also termed a computer-readable medium.

Memory 230 can include executable instructions, and be integrated in, or communicatively coupled to, processor or processing circuitry 210. The executable instructions of the memory 230 can cause processing circuitry 210 to receive/process the instructions to initiate a U2U relay path through a first relay UE to a destination UE by providing a direct communication request to the first relay UE. A U2U relay reselection can be performed to a second relay UE in response to a trigger condition. The trigger condition can be based on at least one of: a measurement of a first or second channel link to the first relay UE being below a (pre)configured threshold, a detection of a radio link failure (RLF) on the first or second channel link, a notification based on a channel link between the first relay UE and the destination UE, or the source UE and the first relay UE, or a reception of a release message. Then the U2U relay can further be established to the destination UE through the second relay UE, as well as other aspects described in this disclosure.

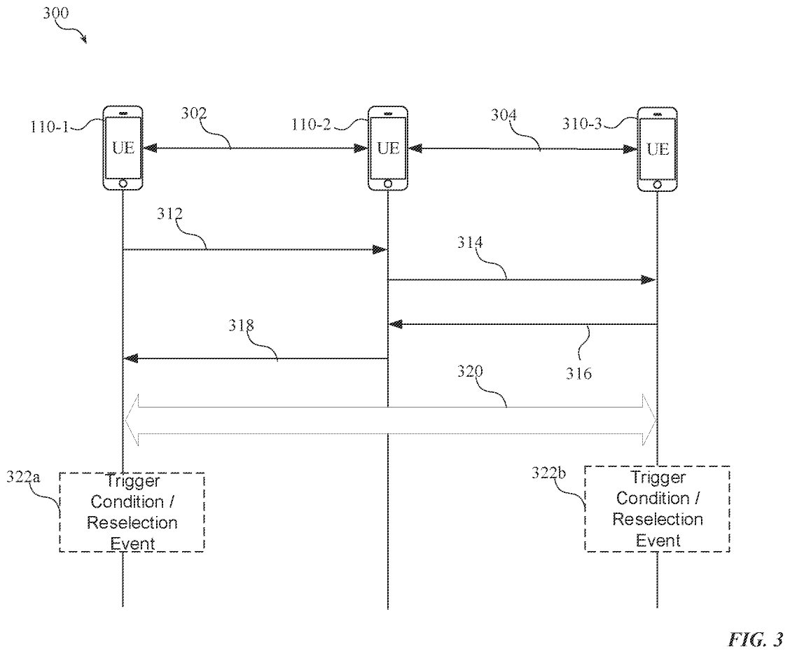

FIG. 3 illustrates example U2U relay communications 300 for operating relay reselection in accord with various aspects. The source UE (e.g., S-UE 110-1), communicates to the relay UE (e.g., R-UE 110-2) via a first channel link 302 and to the destination/target UE (e.g., D-UE 310-3) through the R-UE 110-2 via a second channel link 304. Each of the first and second channel links 302 and 304 can be PC5 interface links and be considered as two relay hops, with one hop being from the S-UE 110-1 to the R-UE 110-2 and another second hop being from the R-UE 110-2 to the D-UE 310-3.

The S-UE 110-1 can operate to trigger relay reselection based various conditions. Relay reselection can refer to the process of changing a previously selected U2U relay and associating with a new U2U, including a new relay-UE that facilitates one or more relay hops between the S-UE 110-1 and a D-UE 310-2 for U2U relay communications. The S-UE can initiate or trigger relay reselection in at least one of various conditions, including: a) the first channel link 302 having a PC5 link quality (e.g., a sidelink (SL) reference signal received power (RSRP), or SL discovery (SD)-RSRP) below a (pre)configured threshold; b) a detection of a PC5 radio link failure (RLF) with R-UE 110-2; c) a reception of PC5-S signaling for L2 release message from R-UE 110-2; or d) a reception of a PC5 RRC notification message. Additionally, or alternatively, the S-UE 110-1 can initiate or trigger relay reselection according to a measurement report from the D-UE 310-3 that can be event triggered, periodic, or requested.

The U2U relay communications 300 can establish U2U 5G ProSe relay where the R-UE 110-2 provides functionality to support connectivity between other UEs. The R-UE 110-2 in particular can be a 5G Pro-Se enabled UE that communicates with a destination or target UE (D-UE 310-3) for the S-UE 110-1. If the S-UE 110-1 intends to broadcast a direct communication request or a solicitation message, it indicates in the message whether a U2U relay could be used. Previously, it was assumed that the value of the indication is restricted to single hop or single direct channel link 302 between UEs. When the R-UE 110-2 receives a direct communication request or a solicitation message (e.g., with a relay indication), then it decides whether to forward the message (i.e. modify the message and broadcast it in its proximity), according to, for example, a relay service code if there is any, application ID, authorization policy (e.g. relay for specific ProSe Service), the current traffic load of the relay, the radio conditions between the source UE and the relay UE, or other associated parameters. Multiple UE-to-UE relays could be also used to reach the target or D-UE 310-3, which can choose which one to reply according to e.g. signal strength, local policy (e.g. traffic load of the UE-to-UE relays), Relay Service Code if there is any or operator policies (e.g. always prefer direct communication or only use some specific UE-to-UE relays). The S-UE 110-1 chooses the communication path according to, for example, signal strength or operator policies.

The R-UE 110-2 can operate to provide its UE to UE relay capability and register accordingly with the network. The authorization and the parameter provisioning can be performed and the U2U relay including the S-UE 110-1 and D-UE 310-3 can be provisioned with relay policy parameters. At least one D-UE 310-3 can determine the destination Layer-2 (L2) ID for signaling reception for PC5 unicast link establishment via the second channel link 304, for example. The destination Layer-2 ID is configured with the D-UE 310-3.

On the S-UE 110-1, the application layer can provide information to the ProSe layer for PC5 unicast communication (e.g., a broadcast Layer-2 ID, ProSe Application ID, UE's Application Layer ID, target UE's Application Layer ID, relay applicable indication). The ProSe layer can trigger the peer UE discovery mechanism by sending an end to end (E2E) broadcast direct communication request (BCAST) message 312. The message 312 can then be sent using the source Layer-2 ID and broadcast Layer-2 ID as destination, and include other parameters related to the application.

The R-UE 110-2 receives the BCAST message 312 and verifies if it is configured to relay this application (i.e., R-UE 110-2 compares the announce ProSe Application ID with its provisioned relay policy/parameters, The R-UE 110-2 forwards the E2E broadcast direct communication request message, BCAST 314, by using its own Layer-2 ID as Source L2 ID, and additionally includes the R-UE's ID in the message with info identifying the S-UE 110-1. The R-UE 110-2 can handle this E2E broadcast message in the ProSe layer, and forwards any subsequent E2E PC5-S message based on adaptation layer information. The D-UE 310-3 can then receive the direct communication request message via the U2U relay (with adaptation layer info).

If D-UE 310-3 participates in the announced application, D-UE 310-3 triggers the per-hop link establishment with the R-UE 110-2 if there is no existing per-hop link between D-UE 310-3 and R-UE 110-2. D-UE 310-3 can send a per-hop link establishment procedure message with its Layer-2 ID as the source and the Layer-2 ID from the U2U relay as the destination. The per-hop link establishment 318 signaling can then be performed between the R-UE 110-2 and S-UE 110-1, if there is no existing per-hop link between the R-UE 110-2 and S-UE 110-1. S-UE 110-1 can then establish its Layer-2 ID as the source and Relay Layer-2 ID as the destination.

If the per hop establishment processes are successful, E2E Authentication and security establishment messages can be exchanged between S-UE 110-1 and D-UE 310-3 via the R-UE 110-2, including the adaptation layer identifying the source or destination UE. At the reception of this first message from UE 310-3 via the U2U Relay, the per-hop link establishment procedure can be performed between the R-UE 110-2 and S-UE 110-1, if there is not an existing per-hop link between the UE-to-UE relay and UE1. As such, per-hop link establishment signaling can be also triggered when S-UE 110-1 receives a first security message from UE-3.

Once end-to-end security is established between UE 310-3 and S-UE 110-1, UE 310-3 completes the end-to-end link establishment between UE 310-3 and S-UE 110-1 by sending an E2E unicast direct communication accept message 316 including the Adaptation layer info identifying S-UE 110-1. R-UE 110-2 forwards the E2E unicast direct communication accept message 318, including the adaptation layer info identifying UE 310-3. Then an extended unicast link 320 can be established between S-UE 110-1 and UE 310-3, via the U2U relay with multiple hops as first channel link 302 and second channel link 304. The extended link 320 is secured end to end, i.e. a security association has been created between S-UE 110-1 and UE 310-3. Confidentiality or integrity/replay protected messages (i.e. data or PC5-S) may be exchanged between S-UE 110-1 and UE 310-3. The R-UE 110-2 is not necessarily involved in the security association, and thus it cannot read nor modify the secured portion of the message (which excludes the source and destination fields).

In addition, the U2U L2 relay operations can be also configured with multiple UE-to-UE relays that can be used to achieve the indirect communication between the S-UE 110-1 and UE 310-3. The selection of the R-UE 110-2 may be based on local configured rules on the UE, or on other R-UE 110-2 selection solutions, e.g. UE-to-UE Relay selection without relay discovery operations.

At 322a or 322b, the S-UE 110-1 or the D-UE 310-3 can initiate or trigger relay reselection in response to at least one of various conditions, including: a) the first channel link 302 having a PC5 link quality (e.g., a sidelink (SL) reference signal received power (RSRP)) below a (pre)configured threshold; b) a detection of a PC5 radio link failure (RLF) with R-UE 110-2; c) a reception of PC5-S signaling for L2 release message from R-UE 110-2; or d) a reception of a PC5 RRC notification message. Additionally, or alternatively, the S-UE 110-1 can initiate or trigger relay reselection according to a measurement report from the D-UE 310-3 that can be event triggered, periodic, or requested.

In various aspects, the L2 U2U relay operations can be configured with at least one second hop (i.e., direct channel link 304 between R-UE 110-2 and D-UE 310-3), which is a PC5 link or interface. Both the S-UE 110-1 and the D-UE 310-3 can be configured to perform or initiate relay reselection. Additionally, when relay reselection is performed (either triggered by the S-UE 110-1 or the D-UE 310-3), the R-UE 110-2 notifies the peer UE or other UE of the relay reselection being triggered. In contrast, U2N has a Uu link between the R-UE 110-2 and a base station or R(AN), only the S-UE 110-1 performs relay reselection, and the notification is not needed from the R-UE because the peer is a gNB, or base station, for example.

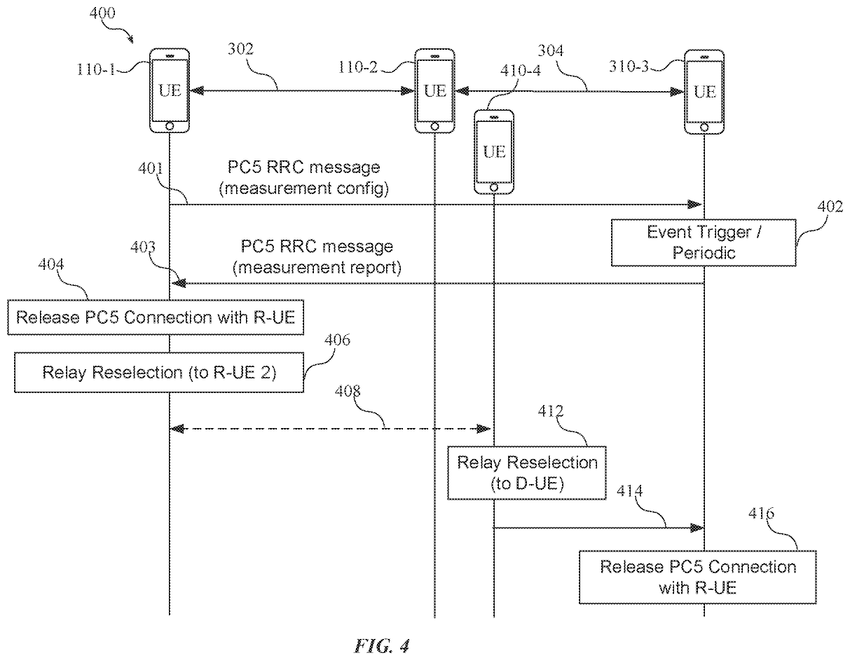

FIG. 4 illustrates another example of U2U communications 400 for U2U relay path recovery and relay reselection along multiple hops that include 302 and 304. Here, the S-UE 110-1 can initiate or trigger relay reselection according to a measurement report from the D-UE 310-3 that can be requested, event triggered, or periodic. Rather than information about the second hop being based on a notification message or RLF, relay reselection can be based on a measurement report 403 generated from D-UE 310-3. This can enable the S-UE 110-1 to consider the radio link quality of the second hop or second PC5 channel link 304 as well as be able to directly measure the first hop 302 (e.g., a SL-RSRP/SD-RSRP/other measure) for determining whether to perform U2U relay reselection.

In an aspect, S-UE 110-1 can perform relay reselection to a new R-UE 410-4 from R-UE 110-2 based on the direct measured quality of link 302, the first hop's PC5 RSRP, and also on the measured quality of the second hop 304 by receiving measurement report by a PC5 RRC message 403.

PC5 RRC message 401 configures PC5 measurement configuration to the D-UE 310-3. The S-UE 110-1 configures the measurement for the D-UE 310-3 by providing a PC5 RRC message with a measurement configuration 401 indicating the measurement (SL-RSRP, SD-RSRP, or other measurement) and the link identification (e.g., 304) to be performed by the D-UE 310-3.

In an aspect, the S-UE 110-1 can also configure D-UE PC5 measurements on serving and neighbor relay UEs. By receiving the measurements by the D-UE 310-3 in the measurement report, the S-UE 110-1 can further select the second relay UE 410-4 based on at least the D-UE's measurements, its own, or both. The PC5 measurement report can be performed by the D-UE 310-3 in response to receiving the message or request 401, or in response to a trigger condition or event trigger that initiates the generation of the measurement report with UE or link 304 measurements by the D-UE 310-3. An event trigger, for example, could be a link quality falling below a threshold, or any other trigger condition as described in this disclosure.

Alternatively, or additionally, D-UE 310-3 can generate the measurement report with measurements to the S-UE 110-1 on a periodic basis or whenever a timer expires. Whenever there is an event triggered/trigger condition, or periodic timer expires, D-UE 310-3 reports measurement to S-UE 110-1 with PC5 measurements of different relay UE candidates PC5, or measurement(s) of the PC5 link 304.

Based on measurements from D-UE 310-3, the S-UE 110-1 can further decide a better new relay UE 410-4 for relay reselection (i.e. release old R-UE 110-2 and reselects to new R-UE 410-4). Then, the new R-UE 410-4 can reselect 412 to D-UE 310-3 based on U2U establishment processes described herein, and notifying the D-UE 310-3 to release the second PC5 link 302 via PC5 RRC notification message 414. Upon reception of notification message 414, D-UE 310-3 releases 416 PC5 link with the old R-UE 110-2.

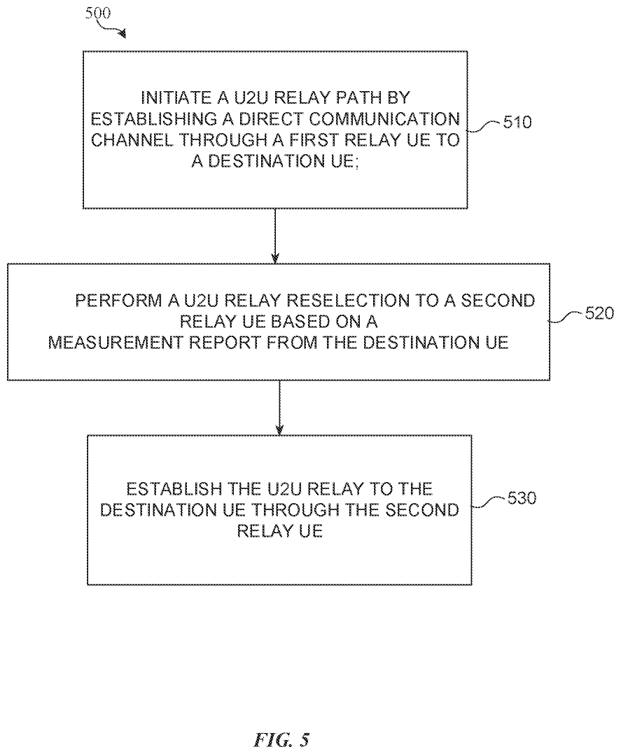

FIG. 5 illustrates another example process flow 500 of U2U relay communication for U2U relay path recovery and relay reselection. At 510, a UE (e.g., S-UE 110-1, or other UE) can initiate a U2U relay path by establishing a direct communication channel through a first relay UE to a destination UE. AT 520, the UE can perform a U2U relay reselection to a second relay UE based on a measurement report from the destination UE. At 530, the UE can establish the U2U relay path to the destination UE through the second relay UE.

The UE can initiate destination UE PC5 measurements on one or more serving and neighbor relay UEs, as well as measurement(s) on a second hop between the destination UE and relay UE of the U2U path. The UE can receive the measurement report in a PC5 RRC message, for example. Additionally, the UE can provide a PC5 RRC message comprising a measurement configuration to configure/request one or more destination UE PC5 measurements on at least one serving relay UE or at least one neighbor relay UE.

The UE can operate to provide a request of the one or more destination UE PC5 measurements on a second channel link between at least one serving relay UE and at least one neighbor relay UE in response to an event trigger. The event trigger comprises at least one of: a measurement of a second channel link from the destination UE to the first relay UE being below a threshold, a detection of an RLF on the second channel link, a reception of a release message, or a notification based on a first channel link between the relay UE and the UE. The UE can then select the second relay UE from among or based on the measurements in the measurement report of at least one serving relay UE or at least one neighbor relay UE by the destination UE.

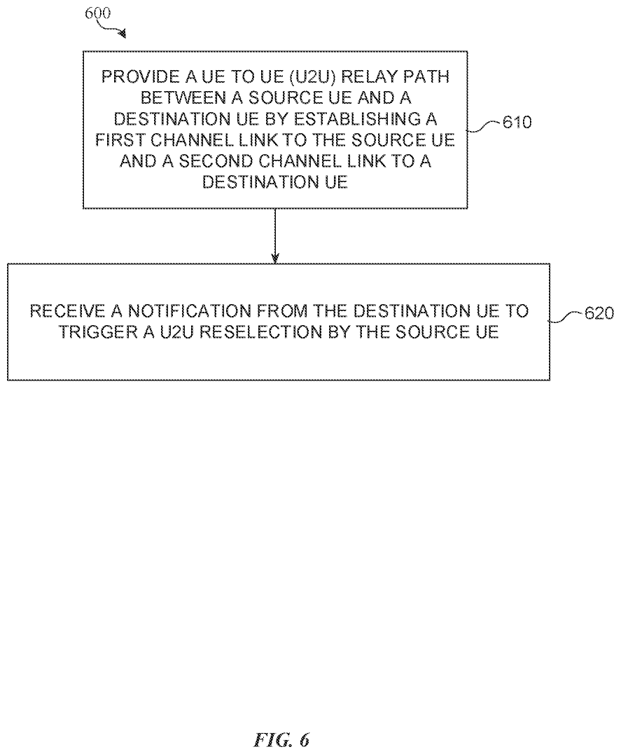

FIG. 6 illustrates another example process flow 600 of U2U relay communication for U2U relay path recovery and relay reselection. At 610, an R-UE (e.g., 410-4 or other relay UE) can provide a U2U relay path between a source UE and a destination UE by establishing a first channel link to the source UE and a second channel link to a destination UE. At 620, the R-UE can then receive notification from the destination UE to trigger a U2U reselection by the source UE. The notification can be based on a measurement or radio link failure (RLM) of the second channel link comprising a second PC5 interface. The notification can comprise a PC5-S signaling with an L2 release message from the source UE or the destination UE. Alternatively, or additionally, the notification can comprise a measurement report from the destination UE. The R-UE can then further provide a release message to the destination UE to release the second channel link via a PC5 RRC message to trigger a release of a PC5 link with another relay UE.

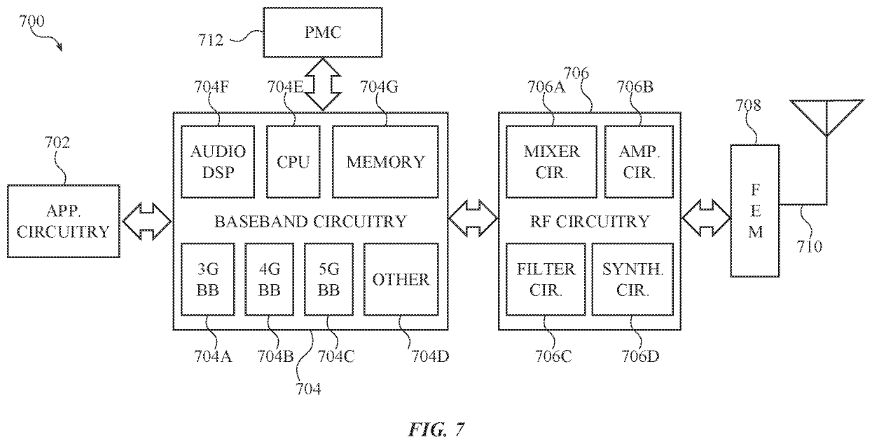

FIG. 7 illustrates example components of a device 700 in accordance with some aspects. In some aspects, the device 700 can include application circuitry 702, baseband circuitry 704, Radio Frequency (RF) circuitry 706, front-end module (FEM) circuitry 708, one or more antennas 710, and power management circuitry (PMC) 712 coupled together at least as shown. The components of the illustrated device 700 can be included in a UE or a RAN node. In some aspects, the device 700 can include fewer elements (e.g., a RAN node cannot utilize application circuitry 702, and instead include a processor/controller to process IP data received from a CN such as 5GC 130 or an Evolved Packet Core (EPC)). In some aspects, the device 700 can include additional elements such as, for example, memory/storage, display, camera, sensor (including one or more temperature sensors, such as a single temperature sensor, a plurality of temperature sensors at different locations in device 700, etc.), or input/output (1/O) interface. In other aspects, the components described below can be included in more than one device (e.g., said circuitries can be separately included in more than one device for Cloud-RAN (C-RAN) implementations).

The application circuitry 702 can include one or more application processors. For example, the application circuitry 702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 700. In some aspects, processors of application circuitry 702 can process IP data packets received from the core network or base station.

The baseband circuitry 704 can include circuitry such as, but not limited to, one or more single-core or multi-core processors. The baseband circuitry 704 can include one or more baseband processors or control logic to process baseband signals received from a receive signal path of the RF circuitry 706 and to generate baseband signals for a transmit signal path of the RF circuitry 706. Baseband circuitry 704 can interface with the application circuitry 702 for generation and processing of the baseband signals and for controlling operations of the RF circuitry 706. For example, in some aspects, the baseband circuitry 704 can include a third generation (3G) baseband processor 704A, a fourth generation (4G) baseband processor 704B, a fifth generation (5G) baseband processor 704C, or other baseband processor(s) 704D for other existing generations, generations in development or to be developed in the future (e.g., second generation (2G), sixth generation (6G), etc.). The baseband circuitry 704 (e.g., one or more of baseband processors 704A-D) can handle various radio control functions that enable communication with one or more radio networks via the RF circuitry 706. In other aspects, some, or all of the functionality of baseband processors 704A-D can be included in modules stored in the memory 704G and executed via a Central Processing Unit 704E. Memory 704G can include executable components or instructions to cause one or more processors (e.g., baseband circuitry 704) to perform aspects, processes or operations herein. The radio control functions can include, but are not limited to, signal modulation/demodulation, encoding/decoding, radio frequency shifting, etc. In some aspects, modulation/demodulation circuitry of the baseband circuitry 704 can include Fast-Fourier Transform (FFT), precoding, or constellation mapping/demapping functionality. In some aspects, encoding/decoding circuitry of the baseband circuitry 704 can include convolution, tail-biting convolution, turbo, Viterbi, or Low Density Parity Check (LDPC) encoder/decoder functionality. Aspects of modulation/demodulation and encoder/decoder functionality are not limited to these examples and can include other suitable functionality in other aspects.

In some aspects, the baseband circuitry 704 can include one or more audio digital signal processor(s) (DSP) 704F. The audio DSP(s) 704F can include elements for compression/decompression and echo cancellation and can include other suitable processing elements in other aspects. Components of the baseband circuitry can be suitably combined in a single chip, a single chipset, or disposed on a same circuit board in some aspects. In some aspects, some, or all of the constituent components of the baseband circuitry 704 and the application circuitry 702 can be implemented together such as, for example, on a system on a chip (SOC).

In some aspects, the baseband circuitry 704 can provide for communication compatible with one or more radio technologies. For example, in some aspects, the baseband circuitry 704 can support communication with a NG-RAN, an evolved universal terrestrial radio access network (EUTRAN) or other wireless metropolitan area networks (WMAN), a wireless local area network (WLAN), a wireless personal area network (WPAN), etc. Aspects in which the baseband circuitry 704 is configured to support radio communications of more than one wireless protocol can be referred to as multi-mode baseband circuitry.

RF circuitry 706 can enable communication with wireless networks using modulated electromagnetic radiation through a non-solid medium. In various aspects, the RF circuitry 706 can include switches, filters, amplifiers, etc. to facilitate the communication with the wireless network. RF circuitry 706 can include a receive signal path which can include circuitry to down-convert RF signals received from the FEM circuitry 708 and provide baseband signals to the baseband circuitry 704. RF circuitry 706 can also include a transmit signal path which can include circuitry to up-convert baseband signals provided by the baseband circuitry 704 and provide RF output signals to the FEM circuitry 708 for transmission.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure is described with reference to attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can be also a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

What is claimed is:

1. A User Equipment (UE) comprising:
processing circuitry, comprising at least one memory, configured to:
initiate a UE to UE (U2U) relay path by establishing a direct communication channel through a first relay UE to a destination UE;
perform a U2U relay reselection to a second relay UE based on a measurement report from the destination UE; and
establish the U2U relay path to the destination UE through the second relay UE.

2. The UE of claim 1, wherein the processing circuitry is further configured to:
initiate destination UE PC5 measurements on one or more serving and neighbor relay UEs.

3. The UE of claim 1, wherein the processing circuitry is further configured to:
receive the measurement report in a PC5 radio resource control (RRC) message.

4. The UE of claim 1, wherein the processing circuitry is further configured to:
provide a PC5 RRC message comprising a measurement configuration to request one or more destination UE PC5 measurements on at least one serving relay UE or at least one neighbor relay UE.

5. The UE of claim 4, wherein the processing circuitry is further configured to:
provide a request of the one or more destination UE PC5 measurements on a second channel link between at least one serving relay UE and at least one neighbor relay UE in response to an event trigger.

6. The UE of claim 5, wherein the event trigger comprises at least one of: a measurement of a second channel link from the destination UE to the first relay UE being below a threshold, a detection of a radio link failure (RLF) on the second channel link, a reception of a release message, or a notification based on a first channel link between the relay UE and the UE.

7. The UE of claim 4, wherein the processing circuitry is further configured to:
provide a request of the one or more destination UE PC5 measurements on a second channel link between at least one serving relay UE and at least one neighbor relay UE in response to a timer expiration.

8. The UE of claim 1, wherein the processing circuitry is further configured to:
select the second relay UE from among measurements in the measurement report of at least one serving relay UE and at least one neighbor relay UE by the destination UE.

9. The UE of claim 1, wherein the processing circuitry is further configured to:
establish the U2U relay path to the destination UE through the second relay UE in response to the second relay UE performing a PC5 link establishment procedure with the destination UE and notifying the destination UE to release a PC5 link with the first relay UE via a PC5 RRC notification message.

10. A User Equipment (UE) comprising:
processing circuitry, comprising at least one memory, configured to
provide a UE to UE (U2U) relay path between a source UE and a destination UE by establishing a first channel link to the source UE and a second channel link to a destination UE; and
receive a notification from the destination UE to trigger a U2U reselection by the source UE.

11. The UE of claim 10, wherein the notification is based on a measurement or radio link failure (RLF) of the second channel link comprising a second PC5 interface.

12. The UE of claim 10, wherein the notification comprises a PC5-S signaling with an L2 release message from the source UE or the destination UE.

13. The UE of claim 10, wherein the notification comprises a measurement report from the destination UE.

14. The UE of claim 10, wherein the processing circuitry is further configured to:
provide a release message to the destination UE to release the second channel link via a PC5 radio resource control (RRC) message to trigger a release of a PC5 link with another relay UE.

15. A method of UE, comprising
initiating, via processing circuitry, a UE to UE (U2U) relay path by establishing a direct communication channel through a first relay UE to a destination UE;
performing a U2U relay reselection to a second relay UE based on a measurement report from the destination UE; and
establishing the U2U relay path to the destination UE through the second relay UE.

16. The method of claim 15, further comprising:
providing a PC5 RRC message comprising a measurement configuration to request one or more destination UE PC5 measurements on at least one serving relay UE or at least one neighbor relay UE.

17. The method of claim 16, further comprising:
providing a request of the one or more destination UE PC5 measurements on a second channel link between at least one serving relay UE and at least one neighbor relay UE in response to an event trigger, wherein the event trigger comprises at least one of: a measurement of a second channel link from the destination UE to the first relay UE being below a threshold, a detection of a radio link failure (RLF) on the second channel link, a reception of a release message, or a notification based on a first channel link between the at least one serving relay UE and the UE.

18. The method of claim 16, further comprising:
selecting the second relay UE from among measurements in the measurement report of at least one serving relay UE and at least one neighbor relay UE by the destination UE.

19. A baseband processor, comprising:
processing circuitry, comprising at least one memory, configured to:
initiate a UE to UE (U2U) relay path by establishing a direct communication channel through a first relay UE to a destination UE;
perform a U2U relay reselection to a second relay UE based on a measurement report from the destination UE; and
establish the U2U relay path to the destination UE through the second relay UE.

20. The baseband processor of claim 19, wherein the processing circuitry is further configured to:
select the second relay UE from among measurements in of at least one serving relay UE and at least one neighbor relay UE by the destination UE.
